(19) United States
(12) Patent Application Publication
(10) Pub. No.: US 2024/0097466 A1
(43) Pub. Date: Mar. 21, 2024

(54) HIGH VOLTAGE OUTPUT DEVICE HAVING SERIAL-PARALLEL STACKED STRUCTURE OF CAPACITORS

(71) Applicant: JEISYS MEDICAL INC., Seoul (KR)

(72) Inventors: Seung Wook LEE, Seoul (KR); Seung In KANG, Seoul (KR); Yeong Gi JEON, Seoul (KR); Si Youn KIM, Seoul (KR); Kyu Young SEO, Seoul (KR); Min Young KIM, Seoul (KR); Won Ju YI, Seoul (KR); Dong Hwan KANG, Seoul (KR)

(73) Assignee: JEISYS MEDICAL INC., Seoul (KR)

(21) Appl. No.: 18/511,381

(22) Filed: Nov. 16, 2023

Related U.S. Application Data
(63) Continuation of application No. PCT/KR2022/005625, filed on Apr. 19, 2022.

(30) Foreign Application Priority Data
May 21, 2021 (KR) 10-2021-0065703

(51) Int. Cl. H02J 7/00; H01G 4/30; H01G 4/38

(52) U.S. Cl. CPC H02J 7/0063; H01G 4/30; H01G 4/38; H02J 7/0013; H02J 2207/50

(57) ABSTRACT

Disclosed is a high voltage output device having a serial-parallel stack structure of capacitors. The high voltage output device includes a substrate includes a capacitor element and a pillar structure provided on an upper surface of the substrate. The substrate includes a first electrode and a second electrode, which have different potentials from each other. The capacitor element is connected to at least one of the first electrode and the second electrode.

### CROSS-REFERENCE TO RELATED APPLICATIONS

The present application is a continuation of International Patent Application No. PCT/KR2022/005625, filed on Apr. 19, 2022, which is based upon and claims the benefit of priority to Korean Patent Application No. 10-2021-0065703 filed on May 21, 2021. The disclosures of the above-listed applications are hereby incorporated by reference herein in their entirety.

### BACKGROUND

Embodiments of the inventive concept described herein relate to a high voltage output device, and more particularly, relate to a high voltage output device having a structure in which capacitors are stacked in series and in parallel.

A pulsed power technology refers to a technology for storing and compressing electrical energy during a specific period and then generating power at a very high output level during a short period. In this case, there are various methods of storing electrical energy, but among the methods, an energy storage method using capacitors is commonly used.

However, when the energy storage method using conventional capacitors employs small capacitors, the voltage capable of being output is limited thereto. When the energy storage method using the conventional capacitors employs several capacitors connected to one another, it may be difficult to miniaturize a device using the energy storage method because the size of the device increases in proportion to the number of capacitors.

### SUMMARY

Embodiments of the inventive concept provide a high voltage output device having a serial-parallel stack structure of capacitors.

In particular, embodiments of the inventive concept provide a high voltage output device that has a low impedance design making it well suitable for pulse power discharge driving and has the high capacitor capacity by having a series-parallel stack structure with high withstand voltage characteristics.

Problems to be solved by the inventive concept are not limited to the problems mentioned above, and other problems not mentioned will be clearly understood by those skilled in the art from the following description.

According to an embodiment, a high voltage output device includes a substrate includes a capacitor element, and a pillar structure provided on an upper surface of the substrate. The substrate includes a first electrode and a second electrode, which have different potentials from each other. The capacitor element is connected to at least one of the first electrode and the second electrode.

In an embodiment of the inventive concept, the capacitor element may include a plurality of capacitor elements.

In an embodiment of the inventive concept, the plurality of capacitor elements may be connected to each other.

In an embodiment of the inventive concept, the plurality of capacitor elements may be connected in series or in parallel.

In an embodiment of the inventive concept, the pillar structure may include a plurality of pillar structures.

In an embodiment of the inventive concept, at least one of the plurality of pillar structures may be provided on the first electrode and connected to the substrate.

In an embodiment of the inventive concept, the substrate may include a plurality of substrates.

In an embodiment of the inventive concept, the plurality of substrates may be stacked through the pillar structure.

In an embodiment of the inventive concept, the capacitor element may be provided such that a plurality of capacitor groups, which are provided as at least two capacitor elements connected in series, is connected in parallel through the first electrode and the second electrode.

In an embodiment of the inventive concept, the first electrode and the second electrode may be provided such that a distance between the first electrode and the second electrode exceeds a predetermined distance, and the second electrode may be provided to surround the first electrode on the substrate.

In an embodiment of the inventive concept, the pillar structure may be made of an alloy material including a metal, of which conductivity exceeds a predetermined degree of conductivity.

In an embodiment of the inventive concept, the high voltage output device may further include a voltage supply module connected to at least one of the pillar structure and supplying power to a load connected to the high voltage output device.

In an embodiment of the inventive concept, the high voltage output device may further include a switch element connected to at least one of the pillar structure and the load and supplying pulse power to the load by being turned on or off.

In an embodiment of the inventive concept, a distance between the first electrode and the second electrode may be determined based on a level of a voltage supplied by the voltage supply module.

In an embodiment of the inventive concept, the pillar structure and the substrate may form a capacitor module having a predetermined degree of capacitance. The capacitance of the capacitor module may be determined based on the number of substrates stacked.

In an embodiment of the inventive concept, a shape of the substrate may be determined by an arrangement structure of the capacitor element included in the substrate.

Other details according to an embodiment of the inventive concept are included in the detailed description and drawings.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 is a block diagram of a high voltage output device, according to an embodiment of the inventive concept;

FIG. 2 is a configuration diagram of a high voltage output device specifically showing the capacitor module of FIG. 1;

FIG. 3 is a diagram for describing a stack structure of one or more substrates, according to an embodiment of the inventive concept;

FIG. 4 is a plan view of a substrate including one or more capacitors, according to an embodiment of the inventive concept; and

FIG. 5 is a diagram for describing a series-parallel arrangement of capacitors, according to an embodiment of the inventive concept.

### DETAILED DESCRIPTION

The above and other aspects, features and advantages of the inventive concept will become apparent from embodiments to be described in detail in conjunction with the accompanying drawings. The inventive concept, however, may be embodied in various different forms, and should not be construed as being limited only to the illustrated embodiments. Rather, these embodiments are provided as examples so that the inventive concept will be thorough and complete, and will fully convey the scope of the inventive concept to those skilled in the art. The inventive concept may be defined by the scope of the claims.

The terms used herein are provided to describe embodiments, not intended to limit the inventive concept. In the specification, the singular forms include plural forms unless particularly mentioned. The terms “comprises” and/or “comprising” used herein do not exclude the presence or addition of one or more other components, in addition to the aforementioned components. The same reference numerals denote the same components throughout the specification. As used herein, the term “and/or” includes each of the associated components and all combinations of one or more of the associated components. It will be understood that, although the terms “first”, “second”, etc., may be used herein to describe various components, these components should not be limited by these terms. These terms are only used to distinguish one component from another component. Thus, a first component that is discussed below could be termed a second component without departing from the technical idea of the inventive concept.

Unless otherwise defined, all terms (including technical and scientific terms) used herein have the same meaning as commonly understood by those skilled in the art to which the inventive concept pertains. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein.

As illustrated in the figures, spatially relative terms, such as “below”, “beneath”, “lower”, “above”, “upper”, and the like, may be used herein for ease of description to describe the relationship between one component and other components. It will be understood that the spatially relative terms are intended to encompass different orientations of the components in use or operation in addition to the orientation depicted in the figures. For example, when inverting a component shown in the figures, a component described as “below” or “beneath” of another component may be placed “above” another element. Thus, the exemplary term “below” may include both downward and upward directions. The components may also be oriented in different directions, and thus the spatially relative terms may be interpreted depending on orientation.

According to an embodiment of the inventive concept, a high voltage output device may be formed such that capacitor elements storing electrical energy have a serial-parallel stack structure, and may be rapidly charged and discharged. In addition, the high voltage output device may output an instantaneous high voltage in a form of pulse energy during discharging.

Hereinafter, an embodiment of the inventive concept will be described in detail with reference to the accompanying drawings.

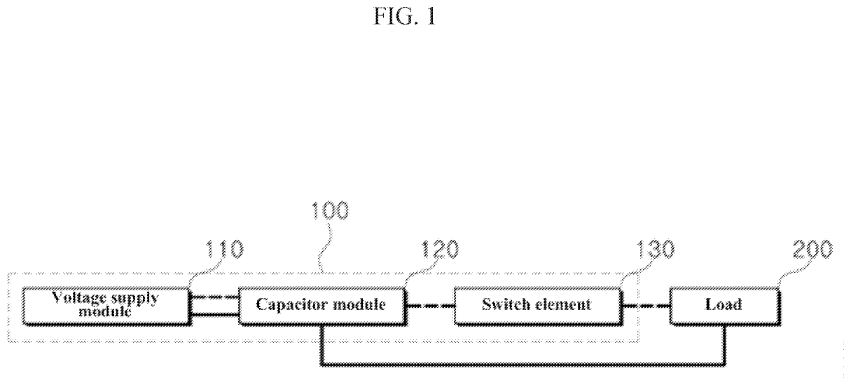

FIG. 1 is a block diagram of a high voltage output device, according to an embodiment of the inventive concept.

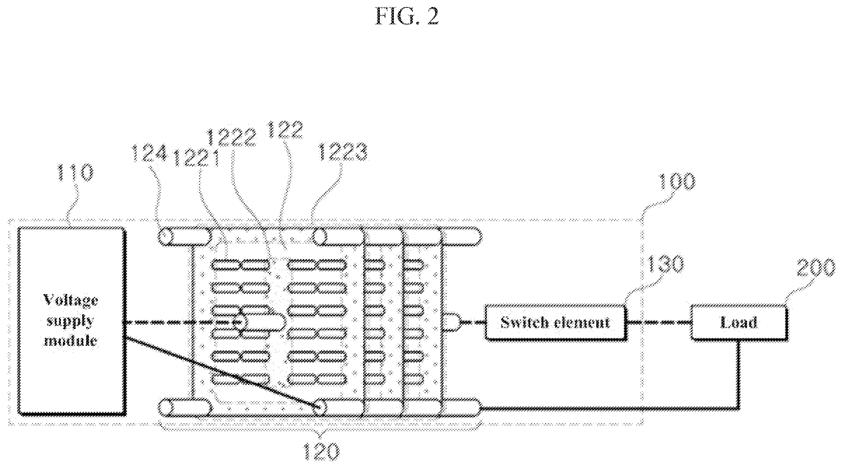

FIG. 2 is a configuration diagram of a high voltage output device specifically showing the capacitor module of FIG. 1.

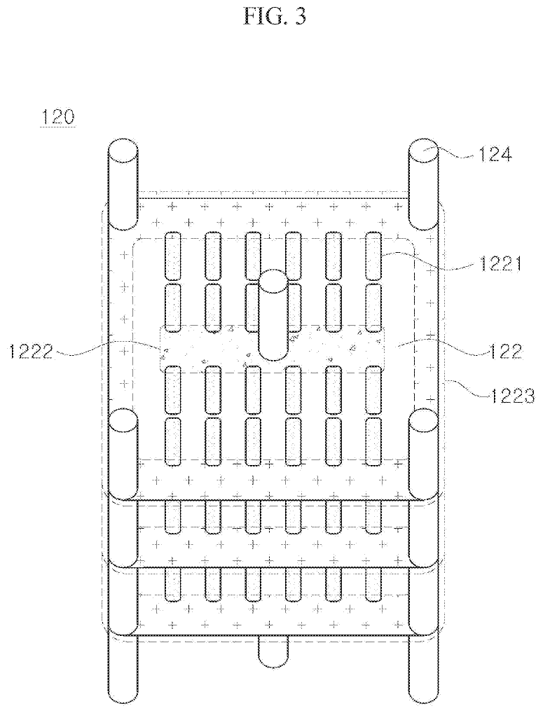

FIG. 3 is a diagram for describing a stack structure of one or more substrates, according to an embodiment of the inventive concept.

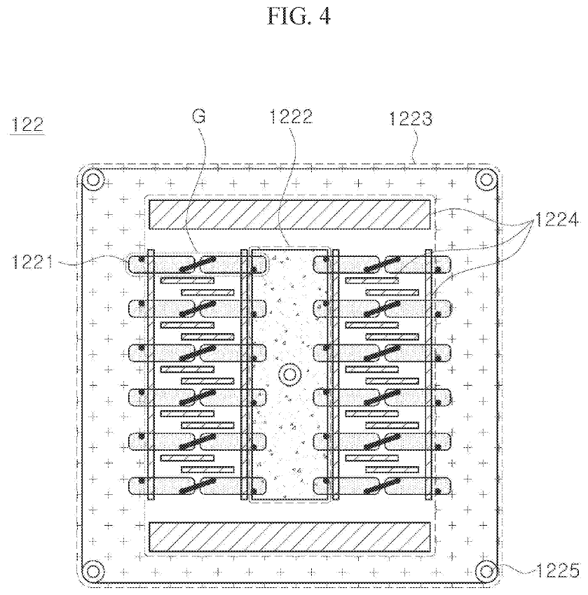

FIG. 4 is a plan view of a substrate including one or more capacitors, according to an embodiment of the inventive concept.

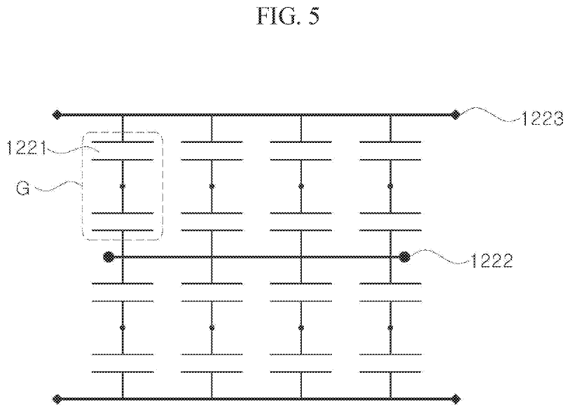

FIG. 5 is a diagram for describing a series-parallel arrangement of capacitors, according to an embodiment of the inventive concept.

Referring to FIG. 1, a high voltage output device 100 may include a voltage supply module 110, a capacitor module 120, and a switch element 130, and the high voltage output device 100 may be connected to a load 200.

However, in some embodiments, the high voltage output device 100 may include fewer or more components than the components illustrated in FIG. 1.

The voltage supply module 110 may supply voltage to the capacitor module 120 such that the capacitor module 120 may store electrical energy.

The voltage supply module 110 may be provided to supply power to the load 200 connected to the high voltage output device 100.

The capacitor module 120 may be a capacitor bank including one or more capacitor elements 1221, and may be provided to charge the one or more capacitor elements 1221 by receiving voltage from the voltage supply module 110.

In an embodiment of the inventive concept, the capacitor may be one or more selected from a film-type capacitor, a tantalum capacitor, a Mylar capacitor, an electrolytic capacitor, and a ceramic capacitor, but is not limited thereto.

In an embodiment of the inventive concept, the capacitor may preferably be a ceramic capacitor. The ceramic capacitor may increase energy by applying a high voltage rather than increasing capacitance because the withstand pressure of the ceramic capacitor is significantly higher than that of other capacitors, but is not limited thereto.

The switch element 130 may be turned on or off such that the capacitor module 120 supplies pulse power to the load 200.

That is, when the switch element 130 is turned off, the capacitor module 120 may charge electrical energy. When the switch element 130 is turned on, the capacitor module 120 may output the charged high voltage energy in a form of a pulse.

The load 200 may consume the pulse power supplied from the capacitor module 120 and may include equipment or modules that are capable of being driven by the high voltage output device 100.

Hereinafter, a connection relationship between components of the high voltage output device 100 according to an embodiment of the inventive concept will be described in detail with reference to FIG. 2.

First, the capacitor module 120 according to an embodiment of the inventive concept may include one or more substrates 122 and one or more pillar structures 124.

Each of the one or more substrates 122 may be connected to the one or more pillar structures 124 and may be stacked. As shown in FIG. 2, three substrates 122 may be connected to the five pillar structures 124 and may be stacked, but the number of substrates 122 and the number of pillar structures 124 are not limited thereto. A detailed description of the capacitor module 120, which is formed of the one or more substrates 122 and the one or more pillar structures 124, will be described later.

Referring to FIG. 2, the voltage supply module 110 may be connected to at least one of the plurality of pillar structures 124.

In more detail, one end of the voltage supply module 110 may be connected to one end of at least one pillar structure 124, which is located on a first electrode 1222 of the substrate 122, from among the plurality of pillar structures 124.

The other end of the voltage supply module 110 may be connected to one end of at least one pillar structure 124, which is located on a second electrode 1223 of the substrate 122, from among the plurality of pillar structures 124.

The switch element 130 may be connected to at least one of the plurality of pillar structures 124.

In more detail, one end of the switch element 130 may be connected to the other end of at least one pillar structure 124, which is located on the first electrode 1222 of the substrate 122, from among the plurality of pillar structures 124.

The switch element 130 may be connected to the load 200.

In more detail, the other end of the switch element 130 may be connected to one end of the load 200.

The load 200 may be connected to at least one of the plurality of pillar structures 124.

In more detail, the other end of the load 200 may be connected to the other end of at least one pillar structure 124, which is located on the second electrode 1223 of the substrate 122, from among the plurality of pillar structures 124.

Hereinafter, the capacitor module 120 according to an embodiment of the inventive concept will be described in detail with reference to FIG. 3.

As described above, the capacitor module 120 according to an embodiment of the inventive concept may include one or more substrates 122 and one or more pillar structures 124.

Each of the one or more substrates 122 may include the one or more capacitor elements 1221 connected to one another in series or in parallel. A description of the series-parallel connection of the capacitor elements 1221 will be provided later.

Each of the one or more substrates 122 may include the first electrode 1222 and the second electrode 1223 having different potentials from each other.

The one or more pillar structures 124 may be provided on an upper surface of each of the one or more substrates 122 to connect the one or more substrates 122 to each other.

The one or more pillar structures 124 may be provided on at least one electrode among the first electrode 1222 and the second electrode 1223, and may electrically connect the substrates 122 to each other or may serve as a support for the stacked substrates 122. FIG. 3 shows that the one pillar structure 124 is placed on the first electrode 1222 (i.e., at the center of the substrate 122) and the four pillar structures 124 are placed on the second electrode 1223 (i.e., at each vertex of the substrate 122). However, the arrangement structure of the pillar structure 124 is not limited thereto.

In addition, FIG. 3 shows that the shape of the substrate 122 is square. However, the shape of the substrate 122 is not limited thereto.

In detail, the shape of the one or more substrates 122 may be determined depending on the arrangement structure of the one or more capacitor elements 1221 included in the one or more substrate. In other words, a shape of the substrate 122 may be determined to be an appropriate shape such as a square, a triangle, or circle depending on an arrangement structure, in which the one or more capacitor elements 1221 are connected to one another, and an arrangement structure in which the one or more capacitor elements 1221 are connected to the first electrode 1222 or the second electrode 1223.

According to an embodiment of the inventive concept, the pillar structure 124 may be made of a metal, of which the conductivity exceeds a predetermined degree of conductivity. For example, the pillar structure 124 may be made of copper. The copper is a metal with high conductivity among metals. When copper is used, a fast and high peak pulse power may be output because impedance is low during signal transmission. As a result, it is possible to solve the problem of impedance generation according to stacking of the substrates 122.

According to an embodiment of the inventive concept, the pillar structure 124 may be made of an alloy material containing a metal, of which the conductivity exceeds the predetermined degree of conductivity. For example, the pillar structure 124 may be provided as a copper alloy. At this time, the copper alloy may mean that the copper content is 80% or more by weight, but is not limited thereto. Because the copper alloy containing copper also has high conductivity, pulse power having a high peak may be output quickly due to low impedance during transmission.

As described above, the copper is used as an example, but metal used as the pillar structure 124 is not limited thereto.

The capacitor module 120 having the predetermined degree of capacitance may be formed by stacking the one or more substrates 122 using the one or more pillar structures 124. That is, the capacitance of the capacitor module 120 may be determined based on the number of substrates 122 stacked through the pillar structure 124.

The one or more capacitor elements 1221 included in each of the one or more substrates 122 may be connected to each other or to at least one of the first electrode 1222 and the second electrode 1223, which have different potentials from each other.

As such, the capacity of the one substrate 122 may be determined as the one or more capacitor elements 1221 included in the one substrate 122 are connected to each other in series or in parallel. For instance, the capacity of the one substrate 122 may be 22 nF, but is not limited to. For instance, the capacity of one substrate 122 may be determined depending on the number of the capacitor elements 1221 and the arrangement structure thereof.

As the one or more substrates 122 are stacked, the substrates 122 may be connected to one another in parallel, and thus the capacitance determined for each of the substrates 122 may be multiplied by the number of substrates 122 to be determined as the capacitance of the capacitor module 120.

In other words, in an embodiment of the inventive concept, the capacitor module 120 having the desired capacity may be designed by adjusting the number of substrates 122. Because the one or more substrates 122 have a stack structure, the capacitor module according to an embodiment of the inventive concept may be miniaturized compared to a conventional capacitor device having the same capacity.

Hereinafter, the structure of the one substrate 122 and the series-parallel connection of the capacitor elements 1221 included in the one substrate 122 will be described in detail with reference to FIGS. 4 and 5.

As described above, each of the one or more substrates 122 includes the first electrode 1222 and the second electrode 1223 having different electrodes from each other.

As shown in FIG. 4, the second electrode 1223 may be configured to surround the first electrode 1222 on each of the one or more substrates 122.

At this time, the first electrode 1222 and the second electrode 1223 may be provided such that a distance between the first electrode 1222 and the second electrode 1223 exceeds a predetermined distance. The distance between the first electrode 1222 and the second electrode 1223 may be determined based on the level of the voltage supplied by the voltage supply module 110. For example, when a DC voltage supplied by the voltage supply module 110 is 9 kV, the distance for insulation per 30 kV at the dielectric strength of air is 1 cm, and the distance between the first electrode 1222 and the second electrode 1223 may be determined to be at least 3 mm. In the meantime, when an AC voltage is applied, a distance for insulation per 21 kV is 1 cm.

According to an embodiment of the inventive concept, when the distance between the first electrode 1222 and the second electrode 1223 is determined in this way, a processing area 1224 may be generated on the substrate 122 by processing the substrate 122 based on the corresponding distance.

Here, the processing area 1224 may be a perforated area or an area to which an insulating material is attached. Moreover, the insulating material may be inserted into the perforated area. That is, when the distance between the first electrode 1222 and the second electrode 1223 is determined to be 3 mm, the processing area 1224 may be generated on the substrate 122 by drilling a hole of a size corresponding to 3 mm, or the processing area 1224 may be generated on the substrate 122 by attaching or inserting an insulating material corresponding to 3 mm.

In an embodiment of the inventive concept, as well as the distance between the first electrode 1222 and the second electrode 1223, the distance between the one or more capacitor elements 1221 and the first electrode 1222 or the second electrode 1223 may also be adjusted. In this case, the distance between the one or more capacitor elements 1221 and the first electrode 1222 or the second electrode 1223 may be determined to be smaller than the distance between the first electrode 1222 and the second electrode 1223.

In this way, in an embodiment of the inventive concept, to secure an insulation distance between the first electrode 1222 and the second electrode 1223 and an insulation distance between the one or more capacitor elements 1221 and the first electrode 1222 or the second electrode 1223, electrical accidents such as short circuits may be prevented by processing the substrate 122.

Each of the one or more substrates 122 may include one or more slots 1225. The slot 1225 may be a recess into which the pillar structure 124 is capable of being inserted. In this case, the number of slots 1225 may be equal to the number of pillar structures 124 or may be greater than the number of pillar structures 124.

The capacitor element 1221 may be provided such that each of a plurality of capacitor groups G, which are formed as the at least two capacitor elements 1221 are connected in series, is connected in parallel through the first electrode 1222 and the second electrode 1223.

In other words, the plurality of capacitor elements 1221 included in the one substrate 122 may be connected in series, for example, by two, to form the one capacitor group G. Each of the plurality of capacitor groups G formed in this way may have one end connected to the first electrode 1222 and the other end connected to the second electrode 1223.

Referring to FIG. 5, when the sixteen capacitor elements 1221 are included in the one substrate 122, the sixteen capacitor elements 1221 may be connected in series two by two to form eight capacitor groups G, and each of the eight capacitor groups G may be connected in parallel to the first electrode 1222 and the second electrode 1223.

According to an embodiment of the inventive concept, the high voltage output device 100 may be miniaturized, may store a high amount of energy, and may output an instantaneous high voltage in a form of pulse power by forming the capacitor module 120 in a structure having the stacked substrates 122, on each of which the plurality of capacitor elements 1221 are connected in series and parallel.

Steps or operations of the method or algorithm described with regard to an embodiment of the inventive concept may be implemented directly in hardware, may be implemented with a software module executable by hardware, or may be implemented by a combination thereof. The software module may reside in a random access memory (RAM), a read only memory (ROM), an erasable programmable ROM (EPROM), an electrically erasable programmable ROM (EEPROM), a flash memory, a hard disk, a removable disk, a CD-ROM, or a computer-readable recording medium well known in the art to which the inventive concept pertains.

Although an embodiment of the inventive concept are described with reference to the accompanying drawings, it will be understood by those skilled in the art to which the inventive concept pertains that the inventive concept may be carried out in other detailed forms without changing the scope and spirit or the essential features of the inventive concept. Therefore, the embodiments described above are provided by way of example in all aspects, and should be construed not to be restrictive.

According to an embodiment of the inventive concept, a device may be miniaturized by stacking substrates with one or more capacitors connected in series or in parallel, and economical products capable of being easily moved and installed, and easily repaired may be developed.

Moreover, because the capacity of a capacitor is determined depending on the number of stacked substrates, high capacity energy may be stored. Accordingly, high voltage pulse power may be output, and thus products with high energy transfer efficiency may be developed.

Effects of the inventive concept are not limited to the effects mentioned above, and other effects not mentioned will be clearly understood by those skilled in the art from the following description.

While the inventive concept has been described with reference to embodiments, it will be apparent to those skilled in the art that various changes and modifications may be made without departing from the spirit and scope of the inventive concept. Therefore, it should be understood that the above embodiments are not limiting, but illustrative.

What is claimed is:

1. A high voltage output device comprising:
a substrate includes a capacitor element; and
a pillar structure provided on an upper surface of the substrate,
wherein the substrate includes a first electrode and a second electrode, which have different potentials from each other, and
wherein the capacitor element is connected to at least one of the first electrode and the second electrode.

2. The high voltage output device of claim 1, wherein the capacitor element includes a plurality of capacitor elements.

3. The high voltage output device of claim 2, wherein the plurality of capacitor elements are connected to each other.

4. The high voltage output device of claim 3, wherein the plurality of capacitor elements are connected in series or in parallel.

5. The high voltage output device of claim 1, wherein the pillar structure includes a plurality of pillar structures.

6. The high voltage output device of claim 5, wherein at least one of the plurality of pillar structures is provided on the first electrode and connected to the substrate.

7. The high voltage output device of claim 1, wherein the substrate includes a plurality of substrates.

8. The high voltage output device of claim 7, wherein the plurality of substrates are stacked through the pillar structure.

9. The high voltage output device of claim 2, wherein the capacitor element is provided such that a plurality of capacitor groups, which are provided as at least two capacitor elements are connected in series, is connected in parallel through the first electrode and the second electrode.

10. The high voltage output device of claim 1, wherein the first electrode and the second electrode are provided such that a distance between the first electrode and the second electrode exceeds a predetermined distance, and
wherein the second electrode is provided to surround the first electrode on the substrate.

11. The high voltage output device of claim 1, wherein the pillar structure is made of an alloy material including a metal, of which conductivity exceeds a predetermined degree of conductivity.

12. The high voltage output device of claim 1, further comprising:
a voltage supply module connected to at least one of the pillar structure and configured to supply power to a load connected to the high voltage output device.

13. The high voltage output device of claim 12, further comprising:
a switch element connected to at least one of the pillar structure and the load and configured to supply pulse power to the load by being turned on or off.

14. The high voltage output device of claim 12, wherein a distance between the first electrode and the second electrode is determined based on a level of a voltage supplied by the voltage supply module.

15. The high voltage output device of claim 1, wherein the pillar structure and the substrate form a capacitor module having a predetermined degree of capacitance, and
wherein the capacitance of the capacitor module is determined based on the number of substrates stacked.

16. The high voltage output device of claim 1, wherein a shape of the substrate is determined by an arrangement structure of the capacitor element included in the substrate.
